(19) United States
(12) Patent Application Publication
(10) Pub. No.: US 2008/0047336 A1
(43) Pub. Date: Feb. 28, 2008

(54) ENGINE TEST CELL CHANGEOVER METHOD

(75) Inventor: Robert E. Cox, Glen Ellyn, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: INTERNATIONAL ENGINE INTELLECTUAL PROPERTY COMPANY, LLC, Warrenville, IL (US)

(21) Appl. No.: 11/467,598

(22) Filed: Aug. 28, 2006

(51) Int. Cl. G01M 15/00; G01L 5/13

(52) U.S. Cl. 73/116

(57) ABSTRACT

A method of changing-over engines in an engine test cell having a dynamometer and a dynamometer shaft defining a centerline, where the engine crankshaft defines a crankshaft centerline, includes the steps of providing a plurality of engine stands in predetermined locations in the test cell with respect to the dynamometer, attaching a set of mount assemblies to the engine in predetermined locations on the engine with respect to the crankshaft, where the set of mount assemblies is specific to the engine, and attaching the set of mount assemblies to the plurality of engine stands. Upon attachment of the set of mount assemblies to the engine and to the engine stands, the crankshaft centerline and the dynamometer centerline are automatically aligned without adjustment of the engine stands or of the set of mount assemblies.

### BACKGROUND OF THE INVENTION

The present invention relates generally to engine test cells used to test the performance of engines. More specifically, the present invention relates to an engine test cell method for changing different types of engines in and out of the test cell.

A conventional engine test cell includes a dynamometer, an engine mount assembly, multiple engine stand jacks, an engine placed onto the engine mount assembly, and various heat exchangers, and various hose and pipe connections to provide the engine with the air and fluid necessary to run the engine. Other components can be used depending on the type of testing to be conducted.

During the set-up of the test cell, the engine crankshaft is coupled to the dynamometer, which is used to measure the torque and rotational speed of the engine. The center of the crankshaft must be aligned to the center of the dynamometer shaft. This alignment process requires the test cell mechanics to adjust, shift and align various components using various tools until the center of the crankshaft is aligned with the center of the dynamometer shaft. Further, pipes need to be fabricated to run to and from the engine.

In the conventional engine test cell, there is little to no standardization between the configurations of the test cell from engine to engine, and particularly, between engine families. For example, if one particular engine is set up in the test cell, and a second engine is to replace the first engine, various steps have to be taken to reconfigure the test cell during the changeover of the engines. Each engine changeover requires the mechanics to reset the jacks, realign the engine to the dynamometer, search for and fabricate air pipes and coolant hoses, among various other steps.

All of the adjustments, measurements and alignments take an excessively long amount of time. In cases where engines of like families are changed over, the process takes approximately 4-hours. In cases where a different engine family is installed in a test cell, the process can take upwards of 16-hours. In addition to the amount of labor used for an engine changeover, there is also a resulting test cell downtime since the test cell cannot be used for testing during the changeover period.

Thus, there is a need for a test cell changeover method that standardizes the engine changeover procedure.

There is also a need for a test cell changeover method that significantly reduces the amount of time needed to change over an engine.

Further, there is a need for a test cell changeover method that requires a minimal amount of tools.

### BRIEF SUMMARY OF THE INVENTION

The above-listed needs are met or exceeded by the present method of changing-over engines in an engine test cell having a dynamometer and a dynamometer shaft defining a centerline, where the engine crankshaft defines a crankshaft centerline. The method includes the steps of providing a plurality of engine stands in predetermined locations in the test cell with respect to the dynamometer, attaching a set of mount assemblies to the engine in predetermined locations on the engine with respect to the crankshaft, where the set of mount assemblies is specific to the engine, and attaching the set of mount assemblies to the plurality of engine stands. Upon attachment of the set of mount assemblies to the engine and to the engine stands, the crankshaft centerline and the dynamometer centerline are automatically aligned without adjustment of the engine stands or of the set of mount assemblies.

An alternate method of changing-over engines in an engine test cell having a dynamometer and a dynamometer shaft defining a centerline, where the engine crankshaft defines a crankshaft centerline is provided. The method includes the steps of selecting an engine to be tested in the test cell from a group of engines, selecting a set of engine mounts that are custom-made for the engine selected, and providing a plurality of engine stands in predetermined locations in the test cell with respect to the dynamometer. Also included are the steps of attaching the set of mount assemblies to the engine in predetermined locations on the engine with respect to the crankshaft, and attaching the set of mount assemblies to the plurality of engine stands. The predetermined locations of the plurality of engine stands in the test cell are the same irrespective of which engine is selected.

A method of aligning a crankshaft centerline of an engine to a dynamometer shaft centerline in a test cell, wherein the test cell is defined by a horizontal direction “z”, is provided. The method includes the steps of providing a plurality of engine stands in predetermined locations in the test cell, where two of the engine stands are a distance z apart, and where the two engine stands are equidistant from the dynamometer shaft centerline a distance z/2. Also included are the steps of providing two mount assembly portions specific for the engine that attach to the engine at two, predetermined locations on the engine, where the predetermined engine locations are equidistant a distance z″ from the crankshaft centerline, and attaching the mount assembly portions to the engine and to the two engine stands, wherein the mount assembly portions generally extend a distance (z/2-z″) from the predetermined engine location.

A method of attaching an engine mount assembly to an engine stand in an engine test cell is provided. The method includes providing a receiving portion on the engine stand, where the receiving portion is a channel having a pin extending from a bottom surface of the channel and extending generally parallel to the engine stand, where the pin has at least one detent. Also included are the steps of providing an extension portion on the engine mount assembly, where the extension portion extends generally perpendicularly to the pin and includes an aperture for receiving the pin, introducing the pin into the aperture to engage the extension portion into the channel, and providing a tool having at least one prong and engaging the prong into the detent to lock the extension portion to the receiving portion.

### BRIEF DESCRIPTION OF THE SEVERAL VIEWS OF THE DRAWINGS

FIG. 1A is a schematic representation of a test cell including a first engine, a dynamometer, and a plurality of engine stands, showing the positional relationship between the centerline C of the dynamometer shaft and the engine stands;

FIG. 1B is a schematic representation of the test cell of FIG. 1A including a second engine, the dynamometer, and the plurality of engine stands, showing the same positional relationship between the centerline C of the dynamometer shaft and the engine stands as FIG. 1A;

FIG. 1C is a front perspective view of the engine stand with a jack bracket tray;

FIG. 1D is a partial perspective view of a receiving portion of the engine stand;

FIG. 2A is a schematic representation of the test cell including the first engine and a first set of engine mounts, showing the positional relationship between a centerline C′ of the engine crankshaft and the first set of engine mounts;

FIG. 2B is a schematic representation of the test cell including the second engine and a second set of engine mounts, showing the positional relationship between the centerline C′ of the engine crankshaft and the second set of engine mounts;

FIG. 3A is a schematic representation of the test cell including the first engine, the engine stands, and the first set of engine mounts, showing the alignment of the centerline C′ of the engine crankshaft with the centerline C of the dynamometer shaft;

FIG. 3B is a schematic representation of the test cell including the second engine, the engine stands, and the second set of engine mounts, showing the alignment of the centerline C′ of the engine crankshaft with the centerline C of the dynamometer shaft;

FIG. 4 is a front perspective view of a rear mount assembly including left and right rear mounts, a rear housing and left and right jack bracket trays;

FIG. 5 is a front perspective view of a front mount assembly including a front mount bracket and left and right jack bracket trays;

FIG. 6 is a front perspective view of a second rear mount assembly including left and right rear mounts and left and right jack bracket trays;

FIG. 7 is a front perspective view of a second front mount assembly including a front mount bracket and left and right jack bracket trays;

FIG. 8 is a front perspective view of an exhaust elbow with a flange connection;

FIG. 9 is a front perspective view of a hold down clamp;

FIG. 10 is a front perspective view of a jacket water supply piping with a “dry break” or “double shut-off” coupling;

FIG. 11 is a front perspective view of a jacket water return piping with a “dry break” or “double shut-off coupling” which mates with the coupling of FIG. 10;

FIG. 12 is a front perspective view of an intercooler assembly;

FIG. 13 is a front perspective view of a charged-air outpipe for connection to the intercooler of FIG. 12 having a Bradford connection;

FIG. 14 is a front perspective view of a charged-air inpipe for connection to the intercooler of FIG. 12 having a Bradford connection;

FIG. 15A is a schematic representation of a test cell including the first engine, the first set of engine mounts, an intercooler, and a first set of charged air pipes;

FIG. 15B is a schematic representation of a test cell including the second engine, the second set of engine mounts, the intercooler, and a second set of charged air pipes; and

FIG. 16 is a front perspective view of a drive shaft connection.

### DETAILED DESCRIPTION OF THE INVENTION

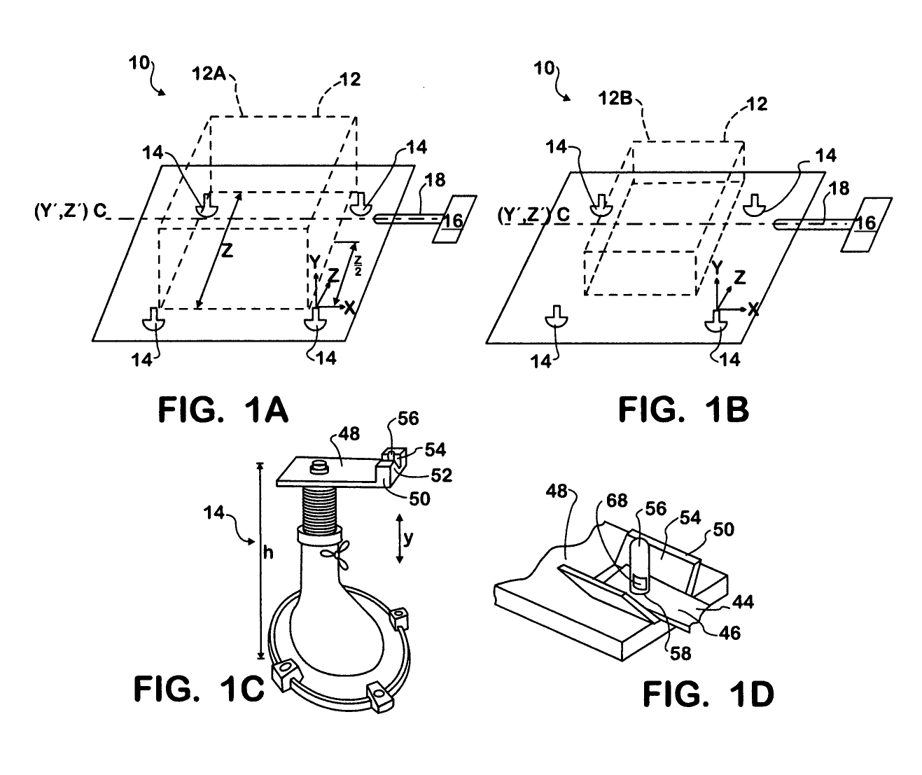

Referring now to FIGS. 1A-1B, schematic representations of a test cell, indicated generally at 10, are provided. The test cell 10 is configured for receiving an engine 12 on a plurality of engine stands 14, each preferably spaced a distance apart. In the preferred embodiment, four engine stands 14 are used, however it is contemplated that the number may vary. The test cell 10 also includes a dynamometer 16 having a dynamometer shaft 18, which is located in operational relationship to the engine 12. In the test cell 10, the engine stands 14 are located a set, predetermined distance from the dynamometer shaft 18 on the test cell floor or other substrate. As measured from the centerline C of the dynamometer shaft 18, each of the engine stands 14 are located a distance (y′, z′). In the most preferred embodiment, at least two of the engine stands 14 are spaced equidistantly from the centerline C of the dynamometer shaft a distance z/2.

According to the method of the present test cell 10, the location of the engine stands 14 in the test cell only have to be set once, even when different engines 12 having different sizes, shapes and arrangements are placed in the test cell. The engine stands 14 are placed in the set, predetermined locations by measurement from the dynamometer shaft 18, or alternatively, a jig can be used. After the engine stands 14 are placed in the predetermined location, they preferably remain in that location. Further, when a plurality of test cells 10 are used, the engine stands 14 are placed in the same, predetermined locations from cell to cell.

By way of example, in FIG. 1A, a first engine model 12A having a particular size, shape and arrangement is placed in the test cell 10. In FIG. 1B, a second engine model 12B having a different, size, shape or arrangement is placed in the test cell 10. In both FIG. 1A and 1B, the engine stands 14 are located in the same location in the test cell 10 relative to the dynamometer 14.

FIG. 1C is a perspective view of a preferred embodiment of engine stand 14. The engine stand 14 is preferably adjustable in the “y” or height direction. However, when the engine stands 14 are initially located in the test cell 10 at the predetermined locations (y′, z′) from the centerline C of the dynamometer shaft, the stands preferably have approximately the same height “h”. Further, in accordance with the present method, once the engine stands 14 are placed in position, the height “h” of the stand does not need to be changed, for example from engine 12A to engine 12B.

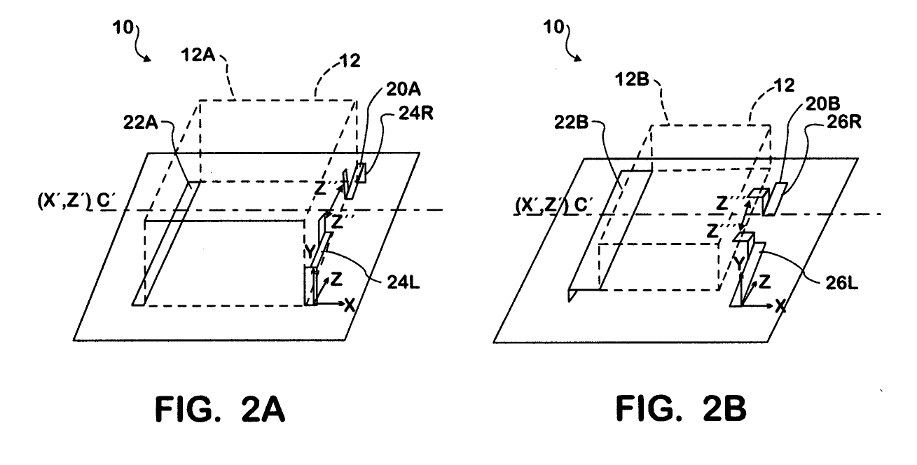

Referring now to FIGS. 2A-2B, schematic drawings of the test cell 10 and the engines 12A and 12B are provided. A centerline corresponding to the centerline of a crankshaft of the engine is indicated at C′. In the schematic view of FIG. 2A, a first rear mount assembly and a first front mount assembly, shown schematically at 20A and 22A, respectively, are attached to the first engine 12A. The rear mount assembly 20A preferably includes a left mount portion 24L and a right mount portion 24R. The left and right mount portions 24L and 24R are each preferably attached to the engine 12 at a set, predetermined location on the engine, and also, each is in the same position relative to the crankshaft centerline C′. As measured from the centerline C′ of the crankshaft, the left mount portion 24L and the right mount portion 24R are preferably both located a distance z″ in the z direction.

Similarly, in the schematic view of FIG. 2B, a second front mount assembly and a second rear mount assembly, shown schematically at 20B and 22B, respectfully, are attached to the second engine 12B. As measured from the centerline C′ of the crankshaft, a left mount portion 26L and a right mount portion 26R are each preferably located a distance z′″ in the z direction. Further, the front mount assembly 20B is also preferably centered with respect to the crankshaft centerline C′ in the z direction. In this configuration, the front mount assemblies 22A, B and the rear mount assemblies 20A, B are preferably centered in the z direction with respect to the crankshaft centerline C′.

As seen between FIGS. 2A and 2B, the front mount assemblies 22A, B and the rear mount assemblies 20A, B are different for engines having a different size, shape or arrangement. The mount assemblies 20, 22 are sized, shaped and arranged to compensate for differentiations among engines 12 so that the configuration of the test cell can remain substantially constant independent of which particular type of engine is tested.

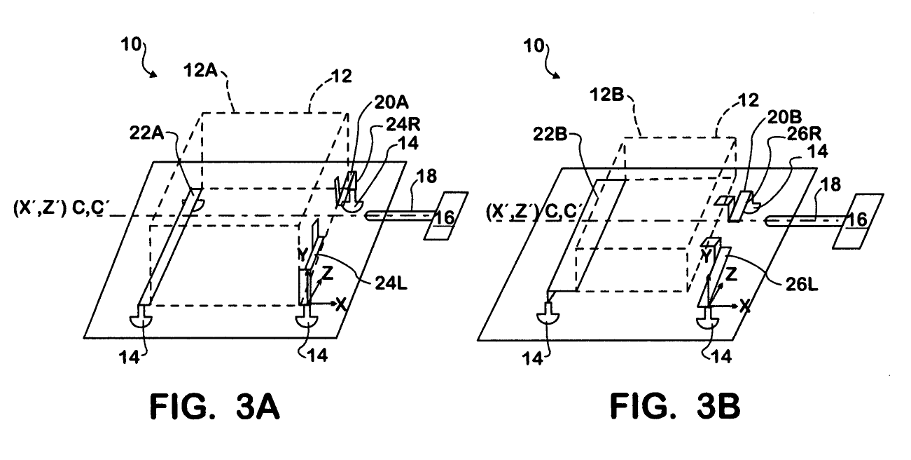

Referring now to FIGS. 3A and 3B, the mount assemblies 20A and 22A attach to the engine 12A at the set, predetermined engine location, and extend to the set, predetermined location of the engine stands 14. For each type of engine 12, a front mount assembly 22 and a rear mount assembly 20 are customized for that particular engine so that when the mount assemblies are attached to the engine at the set, relative location to the crankshaft centerline C′, the mount assemblies will extend to the location of the engine stands 14. In the most preferred embodiment, the left and right mount portions 24 extend from the predetermined location on the engine 12 a distance (z/2-z″) and the left and right mount portions 26 extend from the predetermined location on the engine 12 a distance (z/2-z″′).

If the mount assemblies 20 and 22 are used on the appropriate engines 12 they were customized for, the centerline C′ of the dynamometer shaft and the centerline C″ of the crankshaft will be automatically aligned, which is necessary for the operation of the test cell 10. Additionally, the location of the engine stands 14 in the test cell 10 remains the same whether you have a larger engine, such as engine 12A, or a smaller engine, such as engine 12B.

Further, the customized mount assemblies 20, 22 can be attached to the engine 12 before the engine is placed in the test cell 10. For example, if an engine model 12A is to be changed over for an engine model 12B, the mount assemblies 20B, 22B can be attached to engine 12B while the engine 12A is still being tested in the test cell 10. Additionally, the mount assemblies 20, 22 can be used repeatedly for similar make and model engines. In other words, the mount assemblies 20A, 22A can be used for each engine 12A, for example, each V-6 International Truck® Engine. It is contemplated that each test cell 10 would be provided with a set of mount assemblies 20, 22 in accordance with the types of engines that would be tested. Further, it is contemplated that a set of mount assemblies 20, 22 may be compatible with more than one specific make and model of engine 12.

Before turning to two specific embodiments of mount assemblies 20, 22, it should be understood that the invention should not be limited to the particular size, shape and arrangement of the mount assemblies described below. The mount assemblies 20, 22 can vary in size, shape and arrangement as long as they are configured to align the centerline C′ of the crankshaft with the centerline C of the dynamometer shaft 18 without having to adjust the engine stands 14.

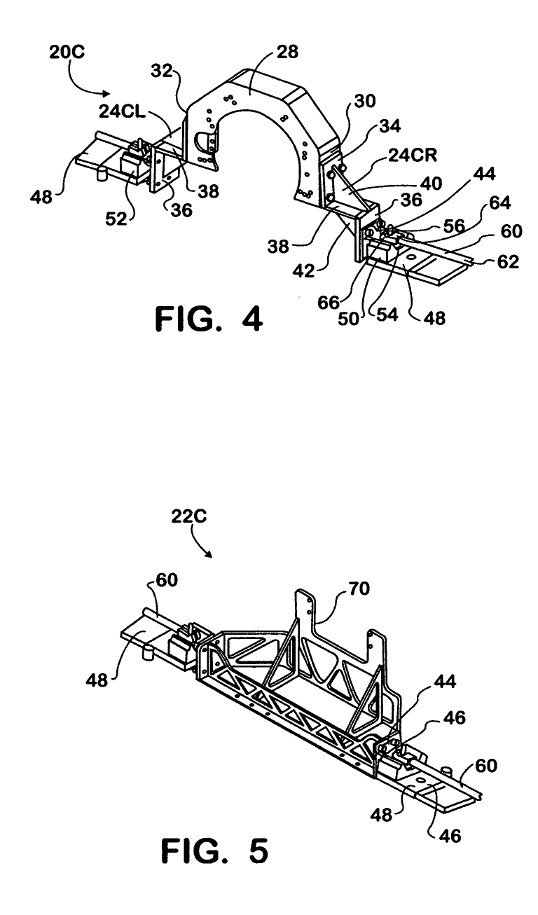

Referring now to FIG. 4, a first embodiment of rear mount assembly 20C is shown. The rear mount assembly 20C includes a left rear mount portion 24CL and a right rear mount portion 24CR attached on both sides to a flywheel housing 28. The flywheel housing 28 is disposed on the engine 12 around the centerline C′ of the crankshaft. Preferably the mirror image of each other, the left and right rear mount portions 24C are attached (preferably bolted) onto the flywheel housing 28 at opposing side surfaces 30, 32.

The left and right rear mount portions 24 preferably include a first portion 34, a second portion 36 generally parallel to the first portion, and a third portion 38 extending between the first and second portions. Two braces 40, 42 are disposed at the connections of the first, second and third portions 34, 36, 38. At the second portion 36, a jack bracket 44 is attached (preferably bolted).

Referring now to FIGS. 4 and 1C, the jack bracket 44 includes an extension portion 46 that is received into a jack bracket tray 48. The jack bracket tray 48 is a tray disposed on top of the engine stand 14. A receiving structure 50 is located on the jack bracket tray 48 and is configured to receive the extension portion 46 of the jack bracket 44. The receiving structure 50 is preferably a block 52 with a channel 54. The channel 54 preferably includes a pin 56, and the extension portion 46 preferably includes an aperture 58 to receive the pin. When the pin 56 is received into the aperture 58 and the extension portion 46 is nested in the channel 54, a tool 60 is used to secure the jack bracket 44 onto the jack bracket tray 48.

The tool 60 includes a handle 62 and a head 64 with two prongs 66. The head 64 is inserted at a generally 45-degree angle around the pin 56. The two prongs 66 slide along the top surface of the extension portion 46 and fits within two pin detents 68. Then, when the prongs 66 are engaged in the detents 68, the tool 60 is rotated to be generally parallel to the jack bracket tray 48, which locks the head 64 in the pin detents 68, and pushes down on the extension portion 46 to force it against the jack bracket tray 48 (see FIG. 4). With this single tool 60, all mount assemblies 20, 22 can be secured to the engine stands. When the rear mount assembly 20C is to be removed from the engine stand 14, the tool 60 is removed by rotating it and withdrawing it from the pin 56.

Turning now to FIG. 5, a first embodiment of a front mount assembly 22C is shown. In the preferred embodiment, the front mount assembly 22C is a truss-like bracket that is attached (preferably by bolting) at a top indentation portion 70 to the front of the engine 12. A truss-like structure is preferred to a solid structure to reduce weight and material costs, and to increase maneuverability.

Similar to the rear mount assembly 20C, the front mount assembly 22C includes a jack bracket 44 with an extension portion 46 that is received in a jack bracket tray 48 of the engine stand 46. Further, the tool 60 is used to secure the front mount assembly 22C as described above with respect to the rear mount assembly 20C.

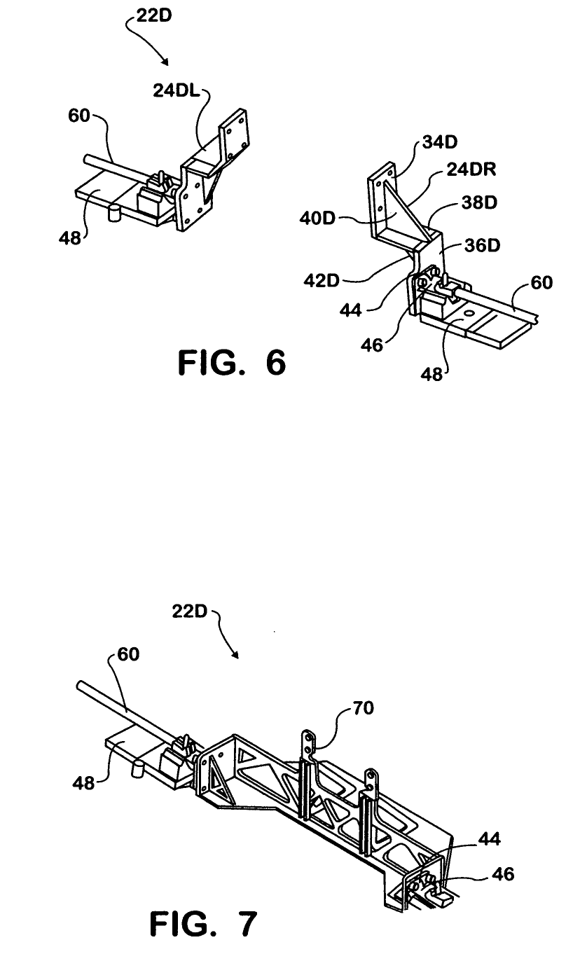

FIG. 6 is a second embodiment of a left and a right rear mount portion 24DL and 24DR, which are configured to be attached to the housing of an engine 12 that is different from the engine of the first embodiment. The left and right rear mount portions 24D attach to the engine 12 at each side of the centerline C′ of the crankshaft. The left and right rear mount portions 24DL and 24DR are preferably the mirror image of each other.

Similar to the first embodiment, the left and right rear mount portions 24D preferably include a first portion 34D, a second portion 36D generally parallel to the first portion, and a third portion 38D extending between the first and second portions. Two braces 40D, 42D are disposed at the connections of the first, second and third portions 34D, 36D, 38D. At the second portion 36D, a jack bracket 44D is attached (preferably bolted).

The second embodiment of the left and right rear mount portions 24D differ from the corresponding first embodiment portions 24C in the particular size, shape and arrangement of the portions 34, 36, 38. Since different engines have different configurations, each set of mount assemblies 20, 22 will have a different arrangement to compensate for these differences, thereby allowing the mount assemblies to both secure the engine and extend to the predetermined location of the engine stands 14.

Turning now to FIG. 7, a second embodiment of a front mount assembly 22D is shown. The front mount assembly 22D is a truss-like bracket having a similar, but slightly different size, shape and arrangement than the assembly 22C. The front mount assembly is also attached (preferably by bolting) at a top indentation portion 70D to the front of the engine 12.

Both the rear mount assembly 20D and the front mount assembly 22D include a jack bracket 44 with an extension portion 46 that is received in a jack bracket tray 48 of the engine stand 46. Also, the tool 60 is used to secure the second embodiment of mount assemblies 20D, 22D as described above with respect to the first embodiment of mount assemblies 20C, 22C. Thus, the tool 60 is not only used for all attachments to the engine stands 14 within a set of mount assemblies 20, 22, but is used for all sets of mount assemblies.

From the above description, it should be appreciated that the present engine-changeover mounting apparatus and method of using the same standardizes the alignment of the centerline of the engine C′ to the centerline C of the dynamometer shaft 18. But in addition to aligning engines of different size, shape and arrangement on different sets of mounts, another aspect of the present test cell change-over method is that the piping connections to and from the engine are simplified.

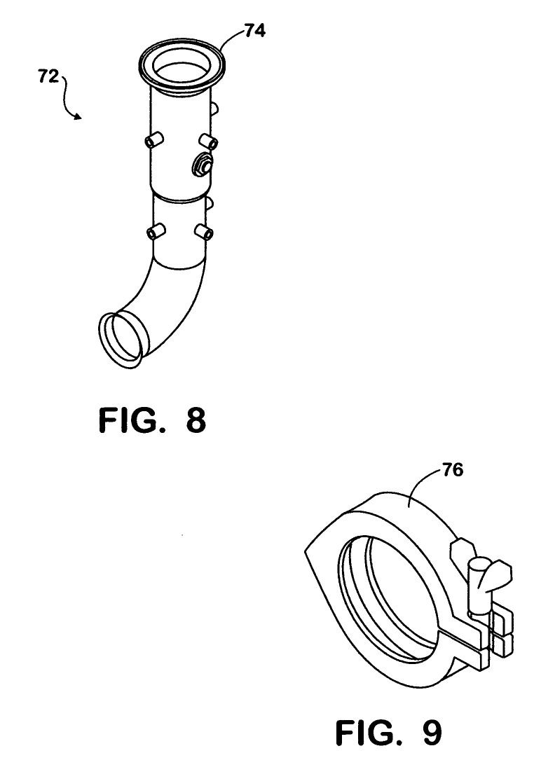

Turning now to FIGS. 8 and 9, an engine exhaust elbow 72 includes a face seal flange 74 for connection to the test cell piping (not shown). A hold-down clamp 76 is used to connect the face seal flange 74 to the test cell piping without the use of any additional tools.

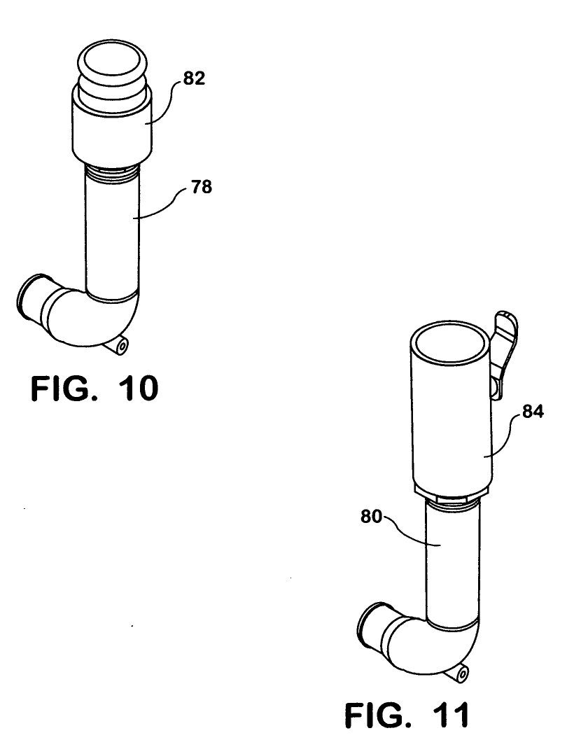

FIGS. 10 and 11 are drawings of a water jacket supply pipe 78 and a water jacket return pipe 80, each with a “dry break” or “double shut-off” coupling 82, 84, respectively. The coupling 82 on the water jacket supply pipe 78 mates with the coupling 84 on the water jacket return pipe 80. The “dry-break” connectors allow the engine 12 to be filled and drained outside of the test cell 10, thus saving time.

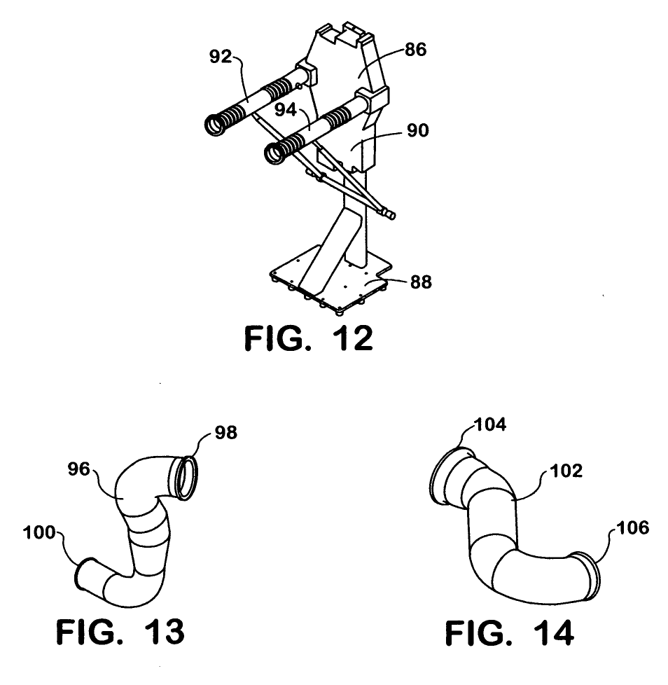

Referring to FIGS. 12-14, an intercooler assembly 86 includes a platform 88, a stand 90 extending generally perpendicularly from the platform, and first and second intercooler pipe arms 92, 94. The first and second arms 92, 94 connect to a charged-air outpipe 96 and a charged-air inpipe 102 from the engine 12.

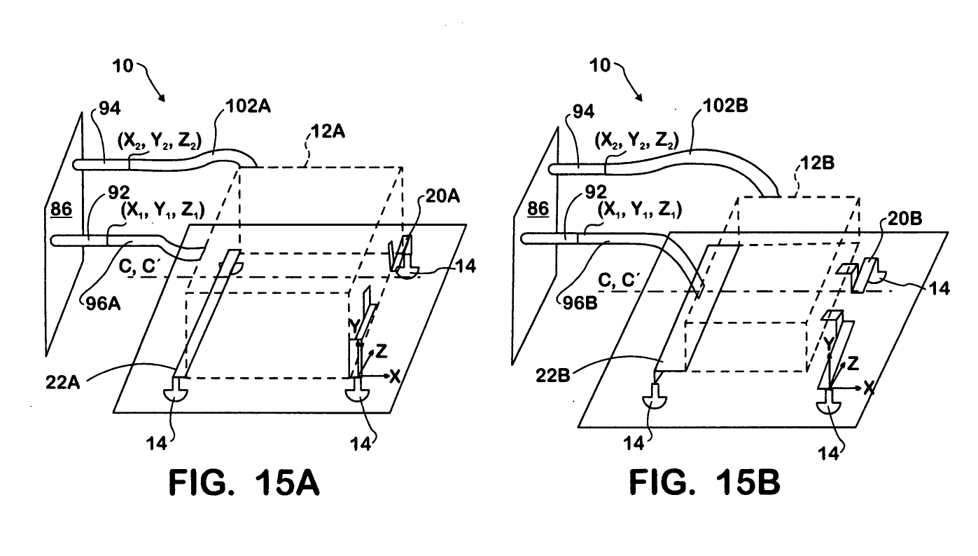

Turning now to FIGS. 13-15, the outpipe 96 and inpipe 102 are unique to each engine family, but regardless of the engine family, when the pipes are attached to the engine, the termination point of the pipes is in the same relative position in space so that they will always connect with the first and second intercooler arms 92, 94 (See FIGS. 15A, 15B). By having a set of outpipes 96 and inpipes 102 for each engine family, this negates the need to use custom bend pipe or to modify each engine pipe configuration regardless of test cell or engine.

As seen in FIG. 13, the charged-air outpipe 96 is configured for connection to the intercooler of FIG. 12. The charged-air outpipe 96 preferably has a Bradford connection 98 for connecting to the intercooler first arm 92, and a barbed end 100 for connection to the engine 12. As seen in FIG. 14, the charged-air inpipe 102 for connection to the second intercooler arm 94 includes a Bradford connection 104. On the other end, the charged-air inpipe 102 has a barbed end 106 for connection to the engine 12. The Bradford connections 98 and 104 are preferably connected to the intercooler arms 92, 94 with hold-down clamps 76 or cam lock connectors.

Referring now to FIG. 15A, a schematic representation of the test cell 10 including the first engine 12A, the first set of engine mounts 20A, 22A, the intercooler 86, and a first set of charged-air pipes 96A, 102A is shown. The charged-air outpipe 96A terminates at point (x₁, y₁, z₁) at the connection to intercooler arm 92, and the charged-air inpipe 102A terminates at point (x₂,y₂,z₂) at the connection to intercooler arm 94. Now, turning to FIG. 15B, a schematic representation of the test cell includes the second engine 12B, the second set of engine mounts 20B, 22B, the intercooler 86, and a second set of charged air pipes 96B, 102B. The second set of charged air pipes 96B, 102B is different from the first set 96A, 102A since a different engine is being tested and further, since the Bradford connection ends 98, 104 preferably terminate in the same relative position. Similar to the test cell of FIG. 15A, the charged-air outpipe 96B terminates at point (x₁, y₁, z₁) at the connection to intercooler arm 92, and the charged-air inpipe 102A terminates at point (x₂,y₂,z₂) at the connection to intercooler arm 94.

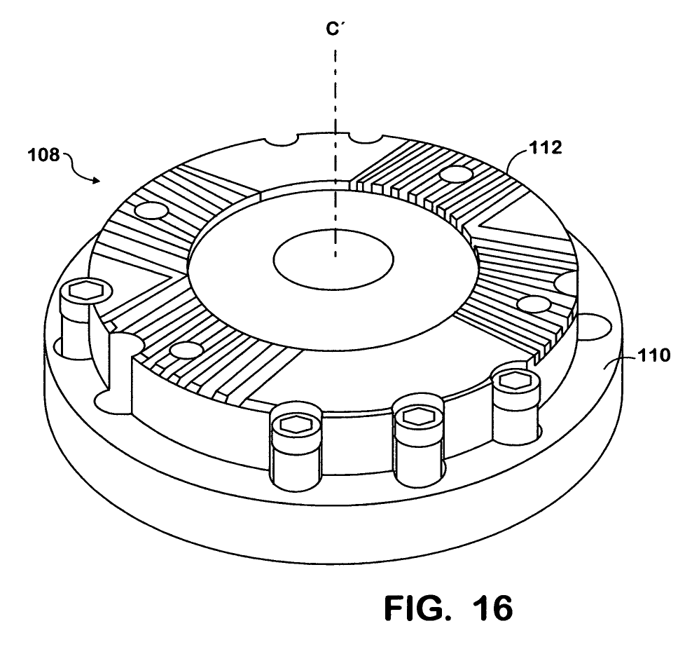

A drive shaft connection 108 is shown in FIG. 16. While the conventional connection is a spicer 8 to 12 bolt smooth flange, the present drive shaft connection 108 is a 4-bolt Hirth style flange 110 having its mating half (not shown) located on the drive plate (not shown). The two halves are machined so that they can be interchanged. This allows the driveshaft to stay connected to the dynamometer 16, and engines to be installed with the other mating half of the flange 110 prior to the engine being selected for a specific test cell 10. The flange 110 has serrations 112 machined at approximately 70-degree angles to each other. The serrations 112 enable the two halves to be self aligning, insuring proper crankshaft centerline C′ alignment with the centerline C of the dynamometer shaft 18.

The present method of placing the engine 12 in the test cell 10 utilizes quick connect fittings for all air and liquid hoses, allowing the engine to be installed with one tool, tool 60. Further, since the engine mount assemblies 20, 22 can be attached to the engines 12 before the engines are placed in the test cell 10, the amount of time to change-over the engines is reduced. Further still, since each engine 12 to be tested has a specific, custom made set of engine mount assemblies 20, 22 that attach to predetermined locations on the engine, and that extend to engine stands that are located at the predetermined locations in the test cell, the engine crankshaft centerline C′ will be automatically aligned with the dynamometer shaft centerline C without having to adjust or align elements of the test cell. With this method, each test cell 10 has a standard configuration irrespective of what kind of engine is tested.

While particular embodiments of the present engine test cell changeover apparatuses and methods of using the same have been shown and described, it will be appreciated by those skilled in the art that changes and modifications may be made thereto without departing from the invention in its broader aspects and as set forth in the following claims.

1. A method of changing-over engines in an engine test cell having a dynamometer and a dynamometer shaft defining a centerline, wherein the engine crankshaft defines a crankshaft centerline, including the steps of:
providing a plurality of engine stands in predetermined locations in the test cell with respect to the dynamometer;
attaching a set of mount assemblies to the engine in predetermined locations on the engine with respect to the crankshaft, wherein said set of mount assemblies is specific to the engine; and
attaching said set of mount assemblies to said plurality of engine stands;
wherein upon attachment of said set of mount assemblies to the engine and to said engine stands, the crankshaft centerline and the dynamometer centerline are automatically aligned without adjustment of said engine stands or of said set of mount assemblies.

2. The method of claim 1 wherein said set of mount assemblies are custom-made for the specific engine such that said mount assemblies attach to the engine at predetermined engine locations and extend to said engine stands.

3. The method of claim 1 further comprising the step of providing at least one of quick connect fittings, dry-break connectors, seal flanges, or hold-down clamps for the connection of at least a portion of all air and liquid hoses.

4. The method of claim 1 further comprising the steps of selecting at least one outpipe and at least one inpipe that are custom made for the engine, wherein said at least one outpipe and at least one inpipe are configured to attach to intercooler pipes of an intercooler, said selected at least one outpipe and inpipe having a termination point in space relative to said intercooler, and attaching said at least one outpipe and inpipe to said intercooler pipes, wherein said termination point in space relative to said intercooler is the same irrespective of which engine is selected.

5. The method of claim 1 further comprising the steps of connecting the crankshaft to the dynamometer with a Hirth style flange.

6. A method of changing-over engines in an engine test cell having a dynamometer and a dynamometer shaft defining a centerline, wherein the engine crankshaft defines a crankshaft centerline, including the steps of:
selecting an engine to be tested in the test cell from a group of engines;
selecting a set of engine mounts that are custom-made for said engine selected;
providing a plurality of engine stands in predetermined locations in the test cell with respect to the dynamometer;
attaching said set of mount assemblies to said engine in predetermined locations on said engine with respect to the crankshaft; and
attaching said set of mount assemblies to said plurality of engine stands;
wherein said predetermined locations of said plurality of engine stands in the test cell is the same irrespective of which engine is selected.

7. The method of claim 6 wherein upon attachment of said set of mount assemblies to the engine and to said engine stands, the crankshaft centerline and the dynamometer centerline are automatically aligned without adjustment of said engine stands or of said set of mount assemblies.

8. The method of claim 6 further comprising the step of providing at least one of quick connect fittings, dry-break connectors, seal flanges, or hold-down clamps for the connection of at least a portion of all air and liquid hoses.

9. The method of claim 6 further comprising the steps of selecting at least one outpipe and at least one inpipe that are custom made for attachment to the selected engine, wherein said at least one outpipe and at least one inpipe are configured to attach to intercooler pipes of an intercooler, said selected at least one outpipe and inpipe having a termination point in space relative to said intercooler, and attaching said at least one outpipe and inpipe to said intercooler pipes.

10. The method of claim 9 wherein said termination point in space relative to said intercooler is the same irrespective of which engine is selected.

11. A method of aligning a crankshaft centerline of an engine to a dynamometer shaft centerline in a test cell, wherein the test cell is defined by a horizontal direction “z”, the method comprising:
selecting an engine from a group of engines;
providing a plurality of engine stands in predetermined locations in the test cell, wherein two of said plurality of engine stands are a distance z apart, and wherein said two engine stands are equidistant from said dynamometer shaft centerline a distance z/2;
providing two mount assembly portions specific for said selected engine that attach to said engine at two, predetermined locations on said engine, wherein said predetermined engine locations are equidistant a distance z″ from the crankshaft centerline; and
attaching said mount assembly portions to said engine and to said two engine stands, wherein said mount assembly portions generally extend a distance (z/2-z″) from said predetermined engine location.

12. The method of claim 11 wherein upon attachment of said mount assembly portions to said engine and to said plurality of engine stands, the crankshaft centerline and the dynamometer centerline are automatically aligned without adjustment of said plurality of engine stands or of said mount assembly portions.

13. The method of claim 11 wherein said predetermined locations of said plurality of engine stands in the test cell is the same irrespective of which engine is selected.

14. The method of claim 11 further comprising the step of selecting said engine mount portions that are custom-made for said engine selected.

15. The method of claim 11 further comprising the steps of selecting at least one outpipe and at least one inpipe that are custom made for attachment to said selected engine, wherein said at least one outpipe and at least one inpipe are configured to attach to intercooler pipes of an intercooler, said selected at least one outpipe and inpipe having a termination point in space relative to said intercooler, and attaching said at least one outpipe and inpipe to said intercooler pipes, wherein said termination point in space relative to said intercooler is the same irrespective of which engine is selected.

16. A method of attaching an engine mount assembly to an engine stand in an engine test cell, comprising:
providing a receiving portion on said engine stand, wherein said receiving portion is a channel having a pin extending from a bottom surface of said channel and extending generally parallel to the engine stand, wherein said pin has at least one detent;
providing an extension portion on the engine mount assembly, wherein said extension portion extends generally perpendicularly to said pin and includes an aperture for receiving the pin;
introducing said pin into said aperture to engage said extension portion into said channel; and
providing a tool having at least one prong and engaging said at least one prong into said detent to lock said extension portion to said receiving portion.

17. The method of claim 4 wherein said pin has a generally cylindrical surface and includes two detents on said generally cylindrical surface, wherein said tool includes two prongs.

18. The method of claim 17 further comprising the steps of engaging said two prongs into said two detents on said pin, and pivoting said tool towards said extension portion until is it generally parallel with said extension portion.

19. The method of claim 17 wherein said two prongs pivot in said detents on said pin.

20. The method of claim 16 wherein after introducing said pin into said aperture, said extension portion is slid down said pin until said extension portion contacts said bottom surface of said channel.
